(19) United States
(12) Patent Application Publication
(10) Pub. No.: US 2013/0167229 A1
(43) Pub. Date: Jun. 27, 2013

(54) TRAFFIC MANAGING DEVICE AND METHOD THEREOF

(71) Applicants: Kyoung-Soon KANG, Daejeon (KR); Hea Sook PARK, Daejeon (KR); Kyeong Ho LEE, Daejeon (KR); Byungjun AHN, Daejeon (KR); Hyunjoo KANG, Daejeon (KR); Yoo Hwa KANG, Daejeon (KR)

(72) Inventors: Kyoung-Soon KANG, Daejeon (KR); Hea Sook PARK, Daejeon (KR); Kyeong Ho LEE, Daejeon (KR); Byungjun AHN, Daejeon (KR); Hyunjoo KANG, Daejeon (KR); Yoo Hwa KANG, Daejeon (KR)

(73) Assignee: Electronics and Telecommunications Research Institute, Daejeon (KR)

(21) Appl. No.: 13/614,528

(22) Filed: Sep. 13, 2012

(30) Foreign Application Priority Data
Dec. 26, 2011 (KR) 10-2011-0142121

(51) Int. Cl. G06F 21/00

(52) U.S. Cl. 726/22

(57) ABSTRACT

Disclosed is a traffic managing device which includes an information collector collecting primary information associated with a flow; a controller judging a traffic state, collecting secondary information associated with the traffic based on the judged traffic state and the primary information, and judging whether the flow is abnormal, based on the secondary information; and a traffic correspondence unit dropping the flow based on the judged traffic state and whether the flow is abnormal. The primary information includes internet protocol addresses of source and destination of the flow and the secondary information includes a flow number of each internet protocol address of a source.

### CROSS-REFERENCE TO RELATED APPLICATIONS

A claim for priority under 35 U.S.C. §119 is made to Korean Patent Application No. 10-2011-0142121 filed Dec. 26, 2011, in the Korean Intellectual Property Office, the entire contents of which are hereby incorporated by reference.

### BACKGROUND

The inventive concepts described herein relate to a traffic managing device and a method thereof.

Networks may be attacked by various manners to interfere in or hinder communication networks. Among the manners, the distributed denial of service (DDOS) may hinder services provided from networks or servers. Since distributed users attack networks or servers using many zombie PCs, it may be difficult to defend the network attack.

To cope with the network attack, a technique may be used which serves only with respect to traffic below a predetermined level by adjusting the amount of traffic. Also, a technique may be used which drops black hole or sink hole routing interworking with a security device. A technique of adjusting traffic without controlling of a flow level may force damage to normal users, not invaders. Also, a technique using a security device may cause an increase in a price according to a size of traffic input to the security device. Thus, it is necessary to adjust a size of traffic processed by the security device.

### SUMMARY

Example embodiments of the inventive concept provide a traffic managing device comprising an information collector collecting primary information associated with a flow; a controller judging a traffic state, collecting secondary information associated with the traffic based on the judged traffic state and the primary information, and judging whether the flow is abnormal, based on the secondary information; and a traffic correspondence unit dropping the flow based on the judged traffic state and whether the flow is abnormal, wherein the primary information includes internet protocol addresses of source and destination of the flow and the secondary information includes a flow number of each internet protocol address of a source.

In example embodiments, the traffic state includes whether the traffic reaches a limit and whether the traffic reaches a danger level.

In example embodiments, whether the traffic reaches a limit is judged by comparing a maximum flow number and a current total flow number.

In example embodiments, whether the traffic reaches a danger level is judged by comparing a critical flow number and a current total flow number.

In example embodiments, the judging whether the flow is abnormal is performed with respect to a flow not belonging to a white list.

In example embodiments, the information collector is connected with the flow by in-line.

In example embodiments, the secondary information has a weight to judge whether the flow is abnormal.

In example embodiments, the primary information includes the protocol of the flow.

In example embodiments, the primary information further includes source and destination ports of the flow.

In example embodiments, the secondary information includes a packet per second (PPS) of the protocol.

In example embodiments, the secondary information includes a total packet per second (PPS), an average packet size, and a flow maintenance time.

Example embodiments of the inventive concept also provide a traffic managing method comprising judging an exceeding state of a traffic; judging a danger level of the traffic according to the exceeding state of the traffic; judging whether the traffic is abnormal, based on the danger level of the traffic; and dropping the flow when the flow is judged to be abnormal.

In example embodiments, the exceeding state of the traffic is judged by comparing a total flow number and a maximum flow number.

In example embodiments, the danger level of the traffic is judged by comparing a total flow number and a critical flow number.

In example embodiments, the traffic managing method further comprises judging whether the flow belongs to a white list; and connecting the flow with a server regardless with whether the flow is abnormal, when the flow belongs to the white list.

In example embodiments, whether the flow is abnormal is judged according to secondary information including a flow number of an internet protocol address of a source and a total packet per second (PPS) of the protocol.

In example embodiments, the secondary information further includes a total PPS, an average packet size, and a flow maintenance time.

In example embodiments, the information is judged with a weight.

In example embodiments, the dropping is maintained during a predetermined time.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a conceptual diagram schematically illustrating interconnection among a traffic managing device, a user, and a server according to an embodiment of the inventive concept.

FIG. 2 is a block diagram schematically illustrating a traffic managing device in FIG. 1.

FIG. 3 is a diagram illustrating traffic information.

FIG. 4 is a flowchart illustrating a traffic managing method according to an embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

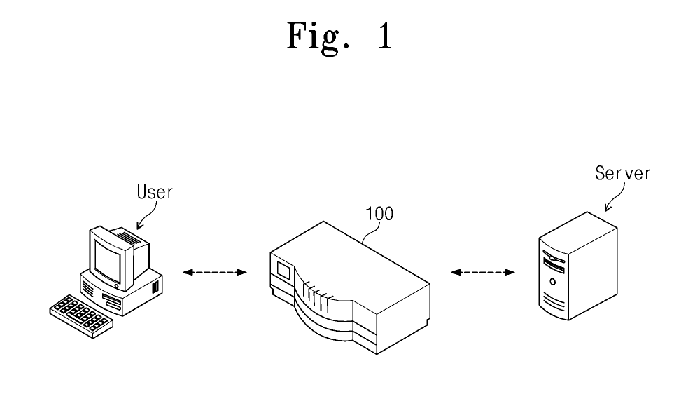

FIG. 1 is a conceptual diagram schematically illustrating interconnection among a traffic managing device, a user, and a server according to an embodiment of the inventive concept. A traffic managing device 100 may be connected with plural users and servers. For ease of illustration, there is exemplarily illustrated the case that the traffic managing device 100 is connected with a user and a server. However, the inventive concept is not limited thereto. The traffic managing device 100 can be connected with two or more users and two or more servers. Also, the traffic managing device 100 may be included within a router. The router may be a relay device placed between different communication networks.

The traffic managing device 100 may receive a flow from the connected user. The user may be an unjustified external network. For example, the user may be a virtual private network (VPN) server, a local area network (LAN) client, or the like. The protocol of a flow generated by the user may not be limited. For example, the user may generate a flow using the TCP protocol. The flow may include information such as internet protocol address and port of a source, internet protocol address and port of a destination, and the protocol.

The traffic managing device 100 may send the flow input from the user to a destination server. The traffic on the destination server may be expressed by a sum of flows passing through the traffic managing device 100 with respect to the destination server. When the traffic is over a predetermined critical value, the traffic managing device 100 may judge whether each flow forming the traffic is normal, that is, an attack intension. The traffic managing device 100 may control the traffic by performing packet drop on a flow judged to be abnormal.

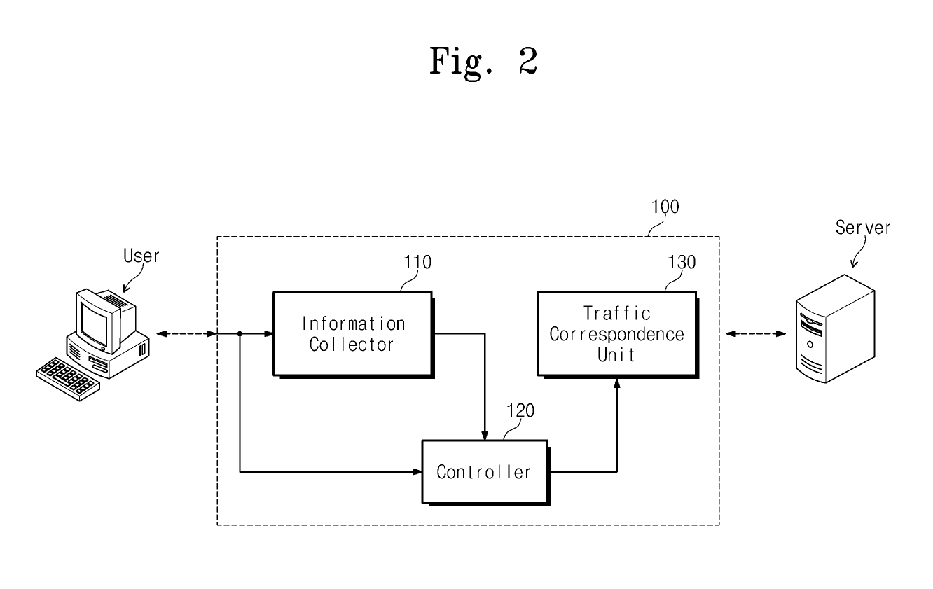

FIG. 2 is a block diagram schematically illustrating a traffic managing device in FIG. 1. Referring to FIG. 2, a traffic managing device 100 may include an information collector 110, a controller 120, and a traffic correspondence unit 130.

The information collector 110 may collect primary information of a flow forming the traffic passing through the traffic managing device 100. The primary information may include an internet protocol address of a source, an internet protocol address of a target, a source port, a target port, and the protocol. The information collector 110 may be connected with a flow generated from the user by in-line. The information collector 110 may send the collected primary information to the controller 120.

The controller 120 may judge whether the traffic passing through the traffic managing device 100 reaches a limit. When a flow number of a current destination server is over a maximum flow number, the controller 120 may judge the traffic to reach a limit. The controller 120 may send a judgment result to the traffic correspondence unit 130.

The controller 120 may judge a danger level of the traffic passing through the traffic managing device 100. The controller 120 may compare a predetermined critical flow number and a current flow number. If the predetermined critical flow number is over the current flow number, the controller 120 may judge the traffic to reach a danger level. The critical flow number may be set to a specific ratio (e.g., 70%) of the maximum flow number.

When the traffic reaches a danger level, the controller 120 may collect secondary information of a flow based on the primary information collected by the information collector 110. The secondary information may be information about each internet protocol address of a source. The secondary information may include a flow number of an internet protocol address of a source, a packet per second (PPS) of the protocol, the whole PPS, an average packet size, and a flow maintenance time.

The controller 120 may judge whether a flow other than a while list is abnormal, based on the secondary information. The while list may be a list of justified users which must be always connected with a destination server. The controller 120 may provide the traffic correspondence unit 130 with the judgment result indicating that each flow is normal.

When the traffic reaches a limit, the traffic correspondence unit 130 may perform packet drop without connecting a flow with the destination server. Also, when the traffic is at a danger level, the traffic correspondence unit 130 may perform packet drop on a flow judged to be abnormal, based on a result input from the controller 120. An abnormal flow may be dropped with respect to the whole packet or only with respect to a part of the whole packet stochastically. The packet drop may be kept during a predetermined time. If connection of a flow judged to be abnormal is tried before a predetermined time does not elapse, the packet drop may be performed without connecting the flow with the destination server.

With the traffic managing device 100 of the inventive concept, continuous service and traffic maintenance may be made with respect to a server during a time when it is attacked by an abnormal flow. Also, the traffic managing device 100 may divide flow information into primary information being basic information and secondary information being detailed information and collect them. This may make it possible to reduce a time taken to search the abnormal traffic. Upon interworking with a security device, the security device may judge whether the traffic passing through the traffic managing device 100 is abnormal, so that the traffic provided to the security device is reduced.

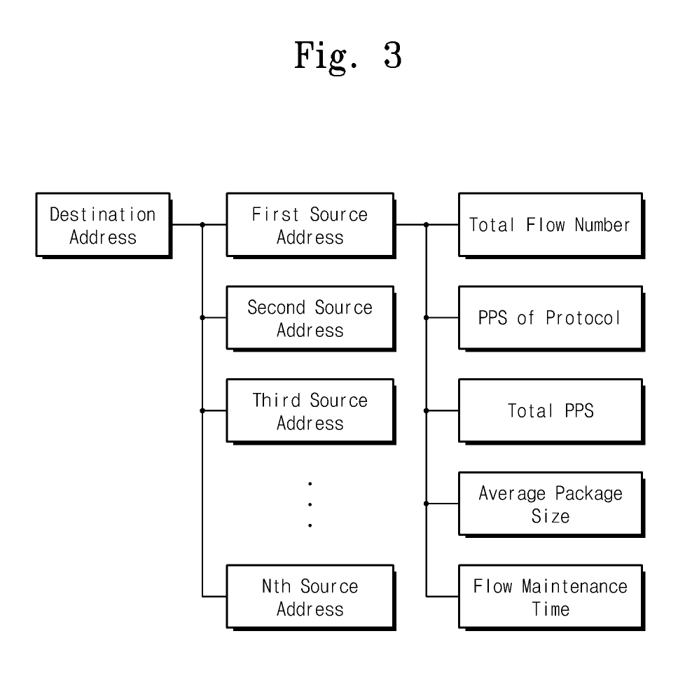

FIG. 3 is a diagram illustrating traffic information. Referring to FIG. 3, a user generating a flow having a corresponding server, that is, an internet protocol address of a source may be collected with respect to a destination server. Secondary information such as a total number of flows generated from a corresponding internet protocol address of a source, PPS of the protocol, a total PPS, an average packet size, and a flow maintenance time may be collected with respect to each internet protocol address of a source.

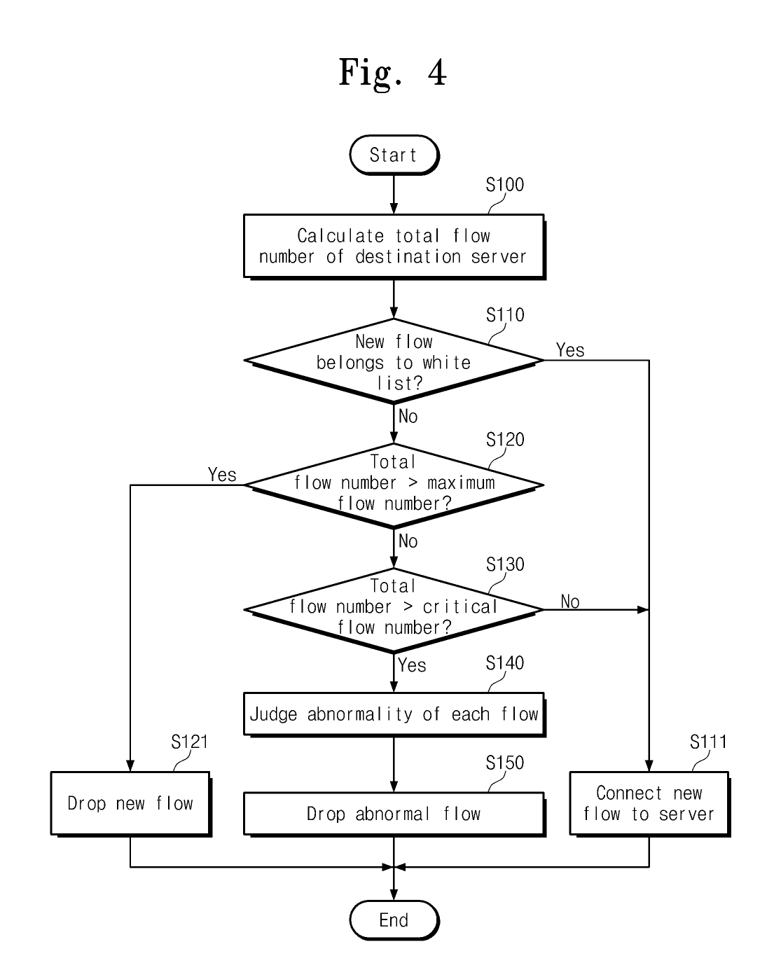

FIG. 4 is a flowchart illustrating a traffic managing method according to an embodiment of the inventive concept. Referring to FIG. 4, in operation S100, a total number of flows to be sent to a destination server may be calculated. An initially set total flow number may be a user number of a white list. If a new flow is received, in operation S110, there may be judged whether the new flow belongs to the write list. If so, the method proceeds to operation S111.

When the new flow does not belong to the write list, the method proceeds to operation S120, in which the calculated total flow number is compared with a predetermined maximum flow number. If the calculated total flow number exceeds the predetermined maximum flow number, the method proceeds to operation S121.

If the calculated total flow number is below the predetermined maximum flow number, the method proceeds to operation S130, in which the calculated total flow number is compared with a predetermined critical flow number. Herein, the critical flow number may be set to a specific ratio on the maximum flow number (e.g., about 70%). If the calculated total flow number is below the critical flow number, the method proceeds to operation S111, in which the new flow is connected with a server.

If the calculated total flow exceeds the critical flow number, the method proceeds to operation S140, in which there is judged whether flows, other than the white list, from among flows forming the current traffic are abnormal. This may be judged according to information including a flow number of an internet protocol address of a source, a packet per second (PPS) of the protocol, the whole PPS, an average packet size, and a flow maintenance time. Respective information may have a weight to be used to judge whether flows are abnormal. In operation S150, a flow judged to be abnormal may be packet dropped.

Below, a traffic managing method will be more fully described. It is assumed that a first user is assigned to a white list with respect to a destination server. Also, it is assumed that a maximum flow number on an appointed server is 5 and a critical flow number is 3. A minimum value of a total flow number may be a user number set to a white list, that is, 1.

It is assumed that a second user and a third user are connected to generate flows with respect to the destination server. The second and third users may be connected with a server, and a total flow number may be 3. At this time, if the first user is connected to generate a flow with respect to the destination server, a flow of the first user may be connected with a server. The reason may be that the first user is included in the total flow number as a white list. The total flow number may maintain 3.

It is assumed that a fourth user is connected to generate a flow with respect to the destination server. In this case, the total flow number may be 4 exceeding a critical flow number. Thus, there may be judged whether flows on the second to fourth users other than the first user set to the white list are abnormal.

Whether a flow is abnormal may be judged according to a flow number of an internet protocol address of a source, a packet per second (PPS) of the protocol, the whole PPS, an average packet size, and a flow maintenance time. For example, such a user that one or more ones of the conditions exceed a predetermined critical value may be judged to generate an abnormal flow. Or, a weight may be added to each condition. It is assumed that the same weight is added to each condition. With this assumption, in case of such a user that three or more ones of five conditions exceed a predetermined critical value, the chance that an abnormal flow is generated may be over 60%. When the generated flow is not an abnormal flow, the fourth user may be connected with a server.

It is assumed that a sixth user is connected to generate a flow with respect to the destination server after a fifth user generating a normal flow is connected with a server. In this case, the total flow number may be 6 exceeding the critical flow number. A flow of the sixth user may be dropped regardless of whether a flow is abnormal. When the total flow number is below the maximum flow number due to disconnection of a previously connected user, an operation of judging whether a flow is abnormal may be resumed.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A traffic managing device comprising:
an information collector collecting primary information associated with a flow;
a controller judging a traffic state, collecting secondary information associated with the traffic based on the judged traffic state and the primary information, and judging whether the flow is abnormal, based on the secondary information; and
a traffic correspondence unit dropping the flow based on the judged traffic state and whether the flow is abnormal,
wherein the primary information includes internet protocol addresses of source and destination of the flow and the secondary information includes a flow number of each internet protocol address of a source.

2. The traffic managing device of claim 1, wherein the traffic state includes whether the traffic reaches a limit and whether the traffic reaches a danger level.

3. The traffic managing device of claim 2, wherein whether the traffic reaches a limit is judged by comparing a maximum flow number and a current total flow number.

4. The traffic managing device of claim 2, wherein whether the traffic reaches a danger level is judged by comparing a critical flow number and a current total flow number.

5. The traffic managing device of claim 1, wherein the judging whether the flow is abnormal is performed with respect to a flow not belonging to a white list.

6. The traffic managing device of claim 1, wherein the information collector is connected with the flow by in-line.

7. The traffic managing device of claim 1, wherein the secondary information has a weight to judge whether the flow is abnormal.

8. The traffic managing device of claim 1, wherein the primary information includes the protocol of the flow.

9. The traffic managing device of claim 8, wherein the primary information further includes source and destination ports of the flow.

10. The traffic managing device of claim 8, wherein the secondary information includes a packet per second (PPS) of the protocol.

11. The traffic managing device of claim 1, wherein the secondary information includes a total packet per second (PPS), an average packet size, and a flow maintenance time.

12. A traffic managing method comprising:
judging an exceeding state of a traffic;
judging a danger level of the traffic according to the exceeding state of the traffic;
judging whether the flow is abnormal, based on the danger level of the traffic; and
dropping the flow when the flow is judged to be abnormal.

13. The traffic managing method of claim 12, wherein the exceeding state of the traffic is judged by comparing a total flow number and a maximum flow number.

14. The traffic managing method of claim 12, wherein the danger level of the traffic is judged by comparing a total flow number and a critical flow number.

15. The traffic managing method of claim 12, further comprising:
judging whether the flow belongs to a white list; and
connecting the flow with a server regardless with whether the flow is abnormal, when the flow belongs to the white list.

16. The traffic managing method of claim 12, wherein whether the flow is abnormal is judged according to secondary information including a flow number of an internet protocol address of a source and a total packet per second (PPS) of the protocol.

17. The traffic managing method of claim 16, wherein the secondary information further includes a total PPS, an average packet size, and a flow maintenance time.

18. The traffic managing method of claim 17, wherein the information is judged with a weight.

19. The traffic managing method of claim 12, wherein the dropping is maintained during a predetermined time.
